(19) United States
(12) Patent Application Publication
(10) Pub. No.: US 2016/0114651 A1
(43) Pub. Date: Apr. 28, 2016

(54) METHODS FOR DETERMINING THE AMBIENT AIR HUMIDITY OF A VEHICLE WITH AN AIR-CONDITIONING SYSTEM, FOR PREVENTING WINDOW MISTING AND FOR DETERMINING WHETHER AN EVAPORATOR IS DAMP OR DRY

(71) Applicant: FORD GLOBAL TECHNOLOGIES, LLC, Dearborn, MI (US)

(72) Inventors: Walter Mayer, Bruehl (DE); Dietmar Fischer, Koln (DE); Markus Markowitz, Koeln (DE)

(21) Appl. No.: 14/886,936

(22) Filed: Oct. 19, 2015

(30) Foreign Application Priority Data
Oct. 27, 2014 (DE) 102014221844.6

(51) Int. Cl. B60H 1/00; B60H 1/32

(52) U.S. Cl. CPC B60H 1/00785; B60H 1/00807; B60H 1/00878; B60H 1/3207

(57) ABSTRACT

A method for determining relative humidity in ambient air of a motor vehicle with an air-conditioning system is provided. That method includes determining, from measurement values of ambient air temperature and the air outlet temperature of an evaporator of the air-conditioning system, the ambient air humidity. Further, that method includes measuring the air outlet temperature of the evaporator at a time at which the compressor of the air-conditioning system was switched on and then has been switched off while the air-conditioning system remains in fan mode, and also after waiting until the evaporator contains no further liquid refrigerant of the air-conditioning system but is still damp.

### TECHNICAL FIELD

This document relates generally to methods for determining the ambient air humidity of a vehicle, for preventing window misting and for determining whether an evaporator of a vehicle air-conditioning system is damp or dry, and corresponding devices for completing these methods.

### BACKGROUND

In motor vehicles, knowledge of the relative humidity in the ambient air is necessary or useful, in particular for regulating the ventilation or air-conditioning system such that the relative humidity in the passenger compartment is as comfortable as possible without the vehicle windows misting up from the outside or inside.

Normally, the ambient air humidity is measured by means of dedicated moisture sensors. Thus DE 10 2009 019 128 A1 discloses determining, by means of moisture sensors, the absolute or relative humidity of the air before and after it flows through the evaporator of a vehicle air-conditioning system, in order to take any necessary measures for drying the evaporator and hence preventing misting of the windows.

Relative humidity sensors, including psychrometers used to measure the relative air humidity, are however relatively costly, provide rather imprecise measurement values and are not always reliable.

The current method is based on the object of simplifying the control and regulation of vehicle air-conditioning systems, in particular to be able to determine the relative humidity in the ambient air of the vehicle with as little cost as possible, to be able to prevent window misting in a simple manner, and also to be able to determine easily whether or not the evaporator is damp.

### SUMMARY

This object is achieved according to the invention with the methods and devices as set forth herein.

The method according to the invention for determining the ambient air humidity is based on the knowledge that, in vehicles with air-conditioning systems, it is possible to conclude the relative humidity from the temperature behavior of the evaporator outlet air after switching off the compressor when the evaporator is damp and while the air-conditioning system is in fan mode, and from the temperature of the ambient air, because there is a clear and reproducible correlation between said temperature measurement values and the actual ambient air humidity as long as the evaporator is damp.

Therefore only very simple and reliable temperature sensors are required to determine the relative humidity of the ambient air.

It is advantageous to obtain the measurement values of the ambient air temperature and air outlet temperature of the evaporator while the vehicle is moving forward at a speed typical of road traffic. In this case, it is guaranteed that the fresh air for the air-conditioning system is at the temperature of the ambient air at its inflow point. It has been found that, on its path to the evaporator through any ducts, the fresh air absorbs a defined heat quantity which results from the drive motor and other vehicle ancillaries such as e.g. the air delivery fan, so that the temperature of the fresh air has risen by a defined value—which is also constant if the air delivery quantity remains the same—when it enters the evaporator. This temperature rise is a vehicle-specific value which is typically around 3K, e.g. between 2K and 4K.

When the air-conditioning system is switched on and the compressor is then switched off while the evaporator is damp, i.e. condensation water has been deposited on the heat exchange surface exposed to the aspirated ambient air, after around one minute all refrigerant in the evaporator of the air-conditioning system will have evaporated. After this one minute, the evaporator is then only cooled by the condensation water still evaporating in the air flow through the evaporator, and hence assumes an approximately constant temperature which depends on the humidity of the ambient air. Only when all condensation water in the evaporator has evaporated—which is typically the case after around 10 minutes—does its temperature rise again, namely to the ambient air temperature plus the abovementioned temperature increase from heat absorption in the vehicle front region.

The greater cooling of the evaporating water film in the evaporator, whose temperature essentially assumes the temperature of the air exiting the evaporator, compared with the temperature of the air entering the evaporator which is known to be the ambient air temperature plus the temperature increase from heat absorption, thus constitutes a measure of the relative humidity of the ambient air. This method of measuring the relative humidity is similar to measurement by means of psychrometers, and the relative humidity can easily be read from a reference table in the same manner as for psychrometer measurements, or be determined using a suitable function or similar.

The air outlet temperature from the evaporator is usually measured as early as possible e.g. after around one or two minutes after switching off the compressor.

The knowledge that the temperature of the fresh air on its path to the evaporator rises during travel by a predefined value, also forms the basis for a method according to the invention for preventing window misting in a vehicle with an air-conditioning system. When the compressor of the air-conditioning system was switched on and has then been switched off, while the air-conditioning system remains in fan mode, it is determined whether the evaporator is damp by monitoring the air outlet temperature from an evaporator of the air-conditioning system, and if it is damp, a currently set dewpoint temperature threshold value for compressor activation is reduced.

Both said methods are based on the knowledge of whether or not the evaporator is damp. It is known from DE 197 28 577 A1 to obtain this knowledge by comparison of the evaporator temperature with the dewpoint temperature of the fresh air, but a dedicated dewpoint sensor or a temperature and humidity sensor pair is required for this.

The knowledge that the temperature of the fresh air on its path to the evaporator rises by a predefined value during driving, forms the basis of a particularly simple method for determining whether an evaporator of a vehicle air-conditioning system is damp or dry, in that the state of the evaporator is simply regarded as damp if the air outlet temperature of the evaporator, around one or two minutes after switching off the compressor while the air-conditioning system remains in fan mode, lies closer to a measured ambient air temperature than the sum of the measured ambient air temperature and a vehicle-specific temperature rise value, and otherwise is simply regarded as dry. This method is admittedly relatively rough but is sufficient for the purposes described herein and possibly further purposes.

### BRIEF DESCRIPTION OF THE DRAWING FIGURES

FIG. 1 is an example of the temporal development of the evaporator air outlet temperature after switching off a vehicle air-conditioning system.

FIG. 2 is a sketch illustration to demonstrate the determination of the evaporator state.

FIG. 3 is a sketch illustration to demonstrate the determination of the ambient air humidity.

### DETAILED DESCRIPTION

In a wind tunnel, a travel of a motor vehicle with internal combustion engine and air-conditioning system was simulated at a speed of 50 kph, wherein the air flowing through the wind tunnel had a temperature of 14° C. and a relative humidity of 60%. A temperature sensor was provided in the air outlet from the evaporator of the air-conditioning system, to measure the air outlet temperature from the evaporator.

The simulated travel was continued with the air-conditioning system running until a stationary state was reached in which the air outlet temperature from the evaporator had assumed a constant value of around 3 to 4° C. Under said conditions, the evaporator is damp and the condensation water quantity deposited on the heat exchange surface of the evaporator is substantially constant since surplus water drips off.

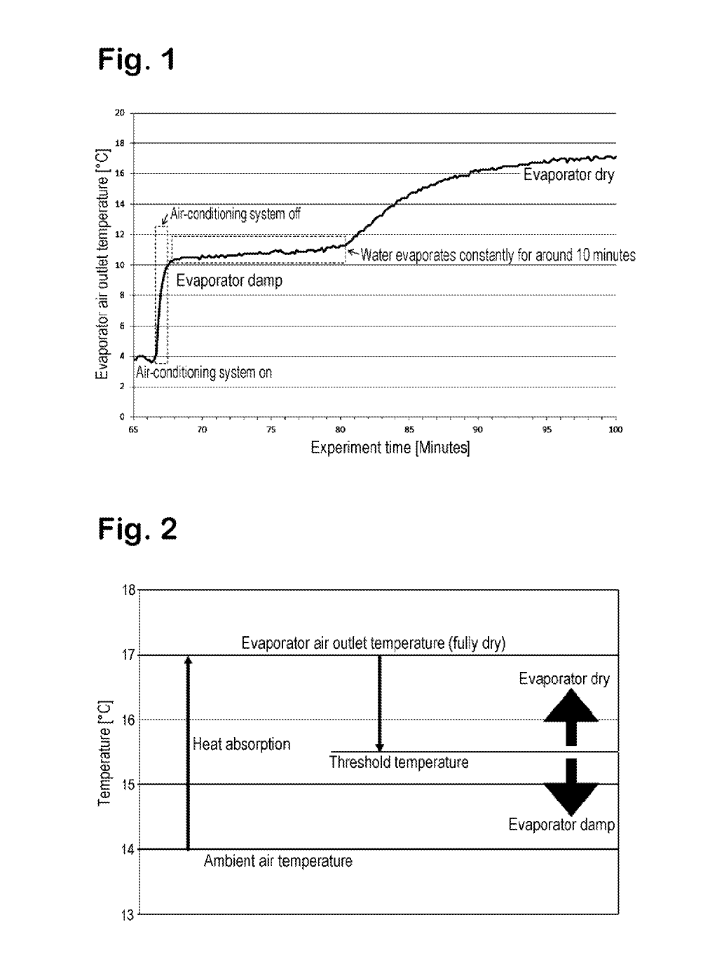

At a certain time—in FIG. 1 at experiment time 67 minutes—the compressor of the air-conditioning system was deactivated and within a period of around one minute, all refrigerant present in the evaporator of the air-conditioning system had evaporated. This phase is marked in FIG. 1 with a vertically elongated, dotted rectangle.

After this around one minute, the evaporator is then cooled only by the evaporating condensation water and assumes an approximately constant temperature. The condensation water here evaporates with a substantially constant drying rate (i.e. quantity per time unit), wherein the air outlet temperature of the evaporator rises only slightly. This phase is indicated in FIG. 1 with a horizontally elongated, dotted rectangle. The air outlet temperature of the evaporator rises only slightly and does not remain fully constant because the evaporator surface dries unevenly.

The level of the air outlet temperature from the evaporator, which is set during this phase of substantially constant water evaporation, is determined by the temperature, speed and humidity of the air flowing over the evaporator surface. Its temperature is the sum of the ambient air temperature and a vehicle-specific temperature rise value from heat absorption from the vehicle, which in this vehicle is 3K, i.e. for this test drive 17° C. Also the speed of the air flowing over the evaporator surface under said conditions is constant or is held as constant as possible.

Thus the resulting air outlet temperature of the evaporator in practice depends only on the relative humidity of the ambient air, and therefore knowledge of the air inlet temperature of the evaporator—which is the ambient air temperature plus a constant temperature rise of here 3K—and measurement of the air outlet temperature of the evaporator at a time around one or a few minutes from switching off the compressor while the evaporator is damp, allows conclusion of the relative ambient air humidity. The drier the air flowing into the evaporator, the lower the resulting temperature level of the evaporator outlet air; therefore the greater cooling of the evaporating water film in the evaporator is a measure of the relative humidity of the air flowing through the evaporator.

When all the condensation water in the evaporator has evaporated, which in the test example was the case after 15 minutes, the air outlet temperature of the evaporator rises again and finally, when the evaporator is completely dry, reaches the 17° C. of the air intake temperature.

Naturally, it is only possible to draw a conclusion about the relative ambient humidity from the ambient air temperature and air outlet temperature of the evaporator if the evaporator is damp when the compressor is switched off.

A particularly simple method of determining the evaporator state as damp or dry when the compressor of the air-conditioning system is switched off but in fan mode, so fresh air still flows through the air-conditioning system, while the vehicle is in motion, is now described with reference to FIG. 2. This method is admittedly relatively rough but adequate for the present purposes.

According to FIG. 2, half the temperature rise value (1.5 K) is deducted from the air inlet temperature of the evaporator—which is equal to the air outlet temperature when the evaporator is fully dry (in the above example 17° C.). It should be appreciated that the air outlet temperature is the ambient air temperature (14° C.) plus 3K temperature increase from heat absorption—in order to define a threshold temperature (15.5° C.). If the air outlet temperature from the evaporator, around one minute after switching off the air-conditioning system, lies below the threshold temperature, the state of the evaporator can be regarded as damp, whereas if it lies above this temperature, it is dry.

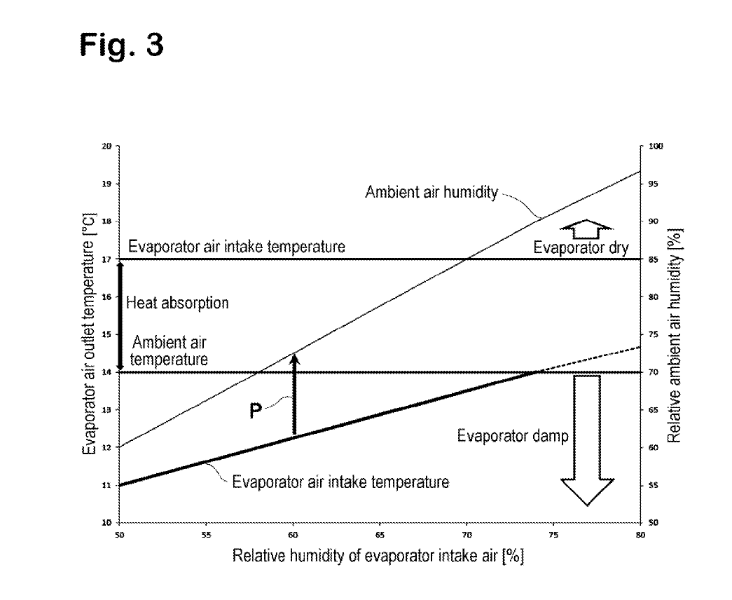

With reference to FIG. 3, an example is now explained for how the relative ambient humidity can be determined in concrete terms, wherein the measurement curves shown in FIG. 3 were determined under the conditions given above (travel speed 50 kph, ambient air temperature 14° C., evaporator air intake temperature 17° C., compressor switched off after around 1 minute, fresh air fan set to 3/7), wherein however the ambient air humidity varied.

FIG. 3 shows the air outlet temperature of the evaporator as a thick line and the relative humidity of the ambient air as a thinner line, each depending on the relative humidity of the evaporator inlet air, wherein both lines are evenly rising functions.

For example, if the level of the air outlet temperature of the evaporator which results during the phase marked with the horizontally elongated, dotted rectangle in FIG. 1, is 12° C., we move from the point on the thick line corresponding to 12° C. vertically upward along arrow P to the thinner line, and on the left-hand scale read the relative humidity of the ambient air belonging to this intersection point, around 73%.

Similarly, for the example of FIG. 1, the ambient air humidity is 60%.

The example of FIG. 3, in which the measurement curves were obtained in relation to the relative humidity of the evaporator inlet air, serves merely for illustration. We see that it is not necessary to know the relative humidity of the evaporator inlet air, and also it is not necessary to carry out the method described here as illustration in order to determine the ambient air humidity.

Rather in practice, an empirically obtained reference table is stored in the air-conditioning system control unit or computing device, which gives the relative humidity of the ambient air belonging to a given ambient air temperature and a given air outlet temperature from the evaporator, in the same way as a table of relative humidity as a function of temperatures at the dry and damp thermometer is used with a psychrometer.

The method described with reference to FIG. 2 for determining whether the evaporator state is damp or dry, also allows a particularly simple method for preventing window misting from condensing moisture from the evaporator when the compressor of the air-conditioning system was in operation but has been switched off while the vehicle is still in motion. This method, like that above, also requires the air-conditioning system to be operating in fan mode and also not in defrost mode.

If by monitoring the air outlet temperature from the evaporator, it is determined in this way that the evaporator is damp, a corresponding marker “evaporator damp” is set.

If the marker “evaporator damp” is set, the current dewpoint temperature threshold value for compressor activation is reduced.

The air outlet temperature continues to be monitored, and if the evaporator is detected as dry, the marker “evaporator damp” is deleted.

If the vehicle is parked and later re-started, it is checked whether the marker “evaporator damp” is set, and if so, the air-conditioning system is automatically switched on immediately and operated so that the windows do not mist up at all.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method for determining relative humidity in ambient air of a motor vehicle with an air-conditioning system, comprising:
determining said relative humidity from measurement values of ambient air temperature and an outlet temperature of an evaporator of said air-conditioning system in a damp state; and
measuring said an outlet temperature of the evaporator at a time at which a compressor of said air-conditioning system was switched on and has then been switched off while said air-conditioning system remains in fan mode and also after waiting until the evaporator contains no further liquid refrigerant of the air-conditioning system but is still damp.

2. The method of claim 1, including obtaining the measurement values while the motor vehicle is moving forward at a speed typical of road traffic.

3. The method of claim 1, including determining the ambient air humidity as a function of the measured air outlet temperature from the evaporator and a temperature value which is the sum of the measured ambient air temperature and a vehicle-specific temperature rise value.

4. The method of claim 3, wherein the temperature rise value is between 2K and 4K

5. The method of claim 3, wherein the air outlet temperature of the evaporator is measured approximately one or two minutes after the compressor of the air-conditioning system has been switched off.

6. A method for preventing window misting in a motor vehicle with an air-conditioning system, wherein a compressor of the air-conditioning system was switched on and has then been switched off and while the air-conditioning system remains in fan mode, comprising:
determining whether the evaporator is damp by monitoring an air outlet temperature of an evaporator of the air-conditioning system, and;
reducing a currently set dewpoint temperature threshold value for compressor activation if a determination is made that the evaporator is damp.

7. The method of claim 6, including determining relative humidity in the ambient air of the motor vehicle using the method as set forth in claim 1.

8. The method of claim 6, including determining relative humidity in the ambient air of the motor vehicle using the method as set forth in claim 2.

9. The method of claim 6, including determining relative humidity in the ambient air of the motor vehicle using the method as set forth in claim 3.

10. The method of claim 6, including determining relative humidity in the ambient air of the motor vehicle using the method as set forth in claim 4.

11. The method of claim 6, including determining relative humidity in the ambient air of the motor vehicle using the method as set forth in claim 5.

12. A method for determining whether an evaporator of a motor vehicle air-conditioning system is damp or dry, comprising determining a state of the evaporator as damp if, at a preset time after a compressor of the air-conditioning system has been switched off and while the air-conditioning system remains in fan mode, an air outlet temperature of the evaporator lies closer to a measured ambient air temperature than a sum of the measured ambient air temperature and a vehicle-specific temperature rise value, and wherein a state of the evaporator is determined as dry if the air outlet temperature of the evaporator lies closer to the sum of the measured ambient air temperature and the vehicle-specific temperature rise value than the measured ambient air temperature.

13. The method of claim 12, including determining relative humidity in the ambient air of the motor vehicle using the method of claim 1.

14. The method of claim 12, including determining relative humidity in the ambient air of the motor vehicle using the method of claim 2.

15. The method of claim 12, including determining relative humidity in the ambient air of the motor vehicle using the method of claim 3.

16. The method of claim 12, including determining relative humidity in the ambient air of the motor vehicle using the method of claim 4.

17. The method of claim 12, including determining relative humidity in the ambient air of the motor vehicle using the method of claim 5.

18. A device in a motor vehicle with an air-conditioning system, wherein the device is configured to perform the method of claim 1.

19. A device in a motor vehicle with an air-conditioning system, wherein the device is configured to perform the method of claim 2.

20. A device in a motor vehicle with an air-conditioning system, wherein the device is configured to perform the method of claim 3.
